(19) United States
(12) Patent Application Publication
(10) Pub. No.: US 2026/0070522 A1
(43) Pub. Date: Mar. 12, 2026

(54) BRAKE CONTROL APPARATUS

(71) Applicant: Hitachi Astemo, Ltd., Ibaraki (JP)

(72) Inventors: Chiharu NAKAZAWA, Ibaraki (JP); Hiromasa YAMASAKI, Ibaraki (JP); Toshiya OOSAWA, Ibaraki (JP)

(21) Appl. No.: 19/107,374

(22) PCT Filed: Aug. 16, 2023
(86) PCT No.: PCT/JP2023/029570

§ 371 Date: Feb. 27, 2025

(30) Foreign Application Priority Data
Sep. 8, 2022 (JP) 2022-142864

(51) Int. Cl. B60T 7/04; B60T 8/36; B60T 13/14; B60T 13/66

(52) U.S. Cl. CPC B60T 7/042; B60T 8/363; B60T 13/147; B60T 13/662

(57) ABSTRACT

The present invention provides a brake control apparatus capable of both curbing cost and minimizing a size increase at the same time when redundancy is implemented for only a required system. A brake control apparatus includes an electromagnetic valve device including a first coil to which a first terminal and a second terminal are connected, and a second coil to which a third terminal and a fourth terminal are connected, in parallel with each other, a housing where the electromagnetic valve device is disposed, and a one control board disposed offset from one end surface of the housing in a direction of an axis around which the first coil is wound. All of the terminals are connected to the one control board.

### TECHNICAL FIELD

The present invention relates to a brake control apparatus.

### BACKGROUND ART

PTL 1 discloses a brake control apparatus in which an electric system is doubled for redundancy as a countermeasure in case of a failure in the electric system and these electric systems are connected to two ECUs including control boards, respectively, and therefore coils of all electromagnetic valves are formed by dual terminals with one system connected to one of the ECUs and the other system connected to the other of the ECUs.

### CITATION LIST

### Patent Literature

PTL 1: Japanese Patent Application Laid-Open No. 2019-48594

### SUMMARY OF INVENTION

### Technical Problem

However, the above-described patent literature, PTL 1 involves such a drawback that this configuration leads to a cost rise and a size increase when only the coils of electromagnetic valves of a required system, such as anti-lock control, are formed by dual terminals.

One of objects of the present invention is to provide a brake control apparatus capable of both curbing cost and minimizing a size increase at the same time when redundancy is implemented for only a required system.

### Solution to Problem

According to one aspect of the present invention, a brake control apparatus includes an electromagnetic valve device including a first coil to which a first terminal and a second terminal are connected, and a second coil to which a third terminal and a fourth terminal are connected, in parallel with each other, a housing where the electromagnetic valve device is disposed, and a one or single control board disposed offset from one end surface of the housing in a direction of an axis around which the first coil is wound. All of the terminals are connected to the one control board.

Therefore, the brake control apparatus according to the one aspect of the present invention can both curb cost and minimize a size increase at the same time when redundancy is implemented for only a required system.

### BRIEF DESCRIPTION OF DRAWINGS

FIG. 1 is a schematic view of a brake control apparatus according to a first embodiment.

FIG. 2 is an exploded perspective view of main parts of the brake control apparatus according to the first embodiment.

FIG. 3(a) is a cross-sectional perspective view of a four-terminal solenoid according to the first embodiment, and FIG. 3(b) is a cross-sectional perspective view of a two-terminal solenoid according to the first embodiment.

FIG. 4 is a perspective view illustrating how the four-terminal solenoid and the two-terminal solenoid according to the first embodiment are mounted on a control board.

FIG. 5 is a plan view of the control board according to the first embodiment.

FIG. 6 is a schematic view of a brake control apparatus according to a second embodiment.

FIG. 7 is a plan view of a control board according to the second embodiment.

FIG. 8 is a schematic view of a brake control apparatus according to a third embodiment.

FIG. 9 is a plan view of a control board according to the third embodiment.

### DESCRIPTION OF EMBODIMENTS

### First Embodiment

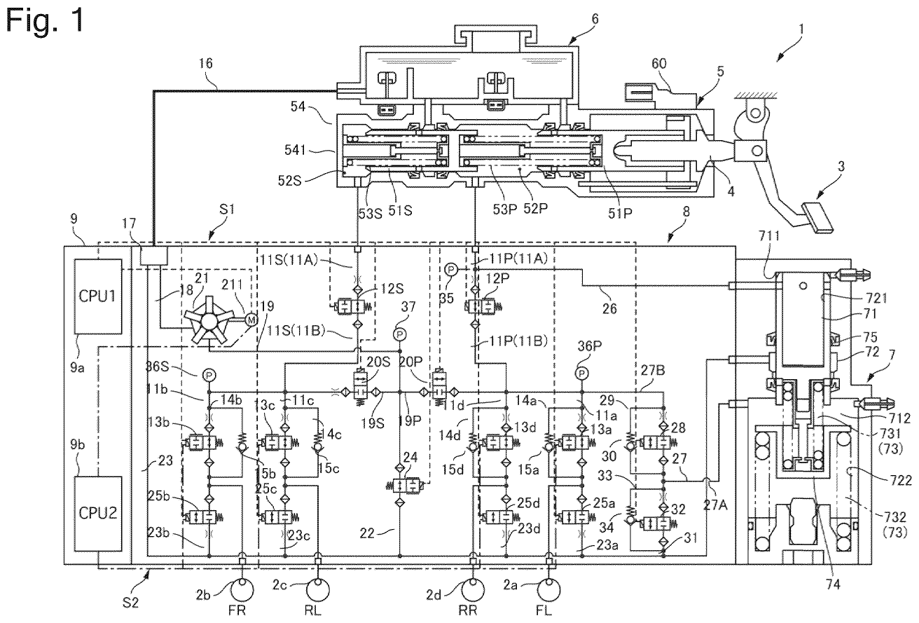

FIG. 1 is a schematic view of a brake control apparatus 1 according to a first embodiment.

### (Configuration of Brake Control Apparatus)

The brake control apparatus 1 is mounted on a hybrid automobile including an electric motor (a generator) in addition to an internal combustion engine, an electric automobile including only an electric motor, and the like, besides a general vehicle including only an internal combustion engine (an engine) as a prime mover that drives wheels.

The brake control apparatus 1 includes a disk brake mounted on each of the wheels (a front left wheel FL, a front right wheel FR, a rear left wheel RL, and a rear right wheel RR) and configured to be actuated according to a hydraulic pressure in a wheel cylinder 2.

The brake control apparatus 1 provides a braking torque to each of the wheels FL to RR by adjusting the hydraulic pressure in the wheel cylinder 2. The brake control apparatus 1 includes two brake pipe systems (a primary P system and a secondary S system). The brake pipe layout is, for example, an X-split pipe layout.

Hereinafter, when a member corresponding to the primary system (hereinafter abbreviated as the P system) and a member corresponding to the secondary system (hereinafter abbreviated as the S system) are distinguished from each other, indexes P and S will be added at the ends of reference numerals thereof. Further, when members respectively corresponding to the wheels FL to RR are distinguished from one another, indexes a to d will be added at the ends of reference numerals thereof.

A brake pedal 3 is a brake operation member that receives an input of a driver's brake operation. A push rod 4 strokes according to the operation on the brake pedal 3. A master cylinder 5 is actuated according to the amount of the stroke of the push rod 4 to generate a brake hydraulic pressure (a master cylinder hydraulic pressure).

The master cylinder 5 is replenished with brake fluid from a reservoir tank 6, which stores the brake fluid therein. The master cylinder 5 is a tandem-type master cylinder, and includes a P piston 51P and an S piston 51S, which stroke according to the stroke of the push rod 4.

These pistons 51P and 51S are arranged in series along the axial direction of the push rod 4. The P piston 51P is connected to the push rod 4. The S piston 51S is configured as a free piston.

A stroke sensor 60 is mounted on the master cylinder 5. The stroke sensor 60 detects the amount of the stroke of the P piston 51P as a pedal stroke amount of the brake pedal 3.

A stroke simulator 7 is actuated in reaction to the driver's brake operation. The stroke simulator 7 generates a pedal stroke with the aid of an inflow of the brake fluid flowing out of inside the master cylinder 5 according to the driver's brake operation performed.

A piston 71 of the stroke simulator 7 is actuated axially in a cylinder 72 against a biasing force of a spring 73 with the aid of the brake fluid supplied from the master cylinder 5. Due to that, the stroke simulator 7 generates an operation reaction force according to the driver's brake operation.

A hydraulic pressure unit 8 can provide a braking torque to each of the wheels FL to RR independently of the driver's brake operation.

The hydraulic pressure unit 8 receives supply of the brake fluid from the master cylinder 5 and the reservoir tank 6. The hydraulic pressure unit 8 is disposed between the master cylinder 5 and the wheel cylinders 2.

The hydraulic pressure unit 8 includes a motor 211 of a pump 21 and a plurality of electromagnetic valves (shut-off valves 12 and the like) as actuators for generating a control hydraulic pressure. The plurality of electromagnetic valves forms an electromagnetic valve device.

The pump 21 sucks the brake fluid from the reservoir tank 6, and discharges the brake fluid toward the wheel cylinders 2. The pump 21 is, for example, a plunger pump or a gear pump. The motor 211 is, for example, a brushed motor.

The plurality of electromagnetic valves (the shut-off valves 12 and the like) performs opening/closing operations according to control signals to switch communication states of fluid passages 11 and the like, thereby controlling the flow of the brake fluid. The hydraulic pressure unit 8 increases the pressures in the wheel cylinders 2 using the brake hydraulic pressure generated by the pump 21 with the master cylinder 5 and the wheel cylinders 2 out of communication with each other. Further, the hydraulic pressure unit 8 includes hydraulic pressure sensors 35 to 37, which detect hydraulic pressures at the respective locations.

A P hydraulic pressure chamber 52P is defined between the two pistons 51P and 51S of the master cylinder 5. A compression coil spring 53P is set in the P hydraulic pressure chamber 52P. An S hydraulic pressure chamber 52S is defined between the S piston 51S and a bottom portion 541 of a cylinder 54. A compression coil spring 53S is set in the S hydraulic pressure chamber 52S. The fluid passage (a connection fluid passage) 11 is opened to each of the hydraulic pressure chambers 52P and 52S. Each of the hydraulic pressure chambers 52P and 52S is connectable to the hydraulic pressure unit 8 via the fluid passage 11 and is also communicable with the wheel cylinders 2.

The driver's operation of pressing the brake pedal 3 causes the strokes of both the pistons 51P and 51S, thereby generating the master cylinder hydraulic pressures according to reductions in the volumes of both the hydraulic pressure chambers 52P and 52S. Generally equal master cylinder hydraulic pressures are generated in these hydraulic pressure chambers 52P and 52S.

As a result, the brake fluid is supplied from both the hydraulic pressure chambers 52P and 52S toward the wheel cylinders 2a to 2d via the fluid passages 11P and 11S, respectively.

More specifically, the master cylinder 5 increases the pressures in the wheel cylinders 2a and 2d of the P system via a fluid passage of the P system (the fluid passage 11P) using the master cylinder hydraulic pressure generated in the P hydraulic pressure chamber 52P. Further, the master cylinder 5 increases the pressures in the wheel cylinders 2b and 2c of the S system via a fluid passage of the S system (the fluid passage 11S) using the master cylinder hydraulic pressure generated in the S hydraulic pressure chamber 52S.

The stroke simulator 7 includes the cylinder 72, the piston 71, and the spring 73.

The cylinder 72 has a cylindrical inner peripheral surface, and includes a piston containing portion 721 and a spring containing portion 722.

The piston containing portion 721 is smaller in diameter than the spring containing portion 722. A fluid passage 27, which will be described below, is constantly opened on the inner peripheral surface of the spring containing portion 722.

The piston 71 is axially movable in the piston containing portion 721. The piston 71 divides the inside of the cylinder 72 into a positive-pressure chamber 711 and a back-pressure chamber 712.

A fluid passage 26 is constantly opened to the positive-pressure chamber 711. The fluid passage 27 is constantly opened to the back-pressure chamber 712.

A piston seal 75 is set on the outer periphery of the piston 71. The piston seal 75 is in sliding contact with the inner peripheral surface of the piston containing portion 721, and seals between the inner peripheral surface of the piston containing portion 721 and the outer peripheral surface of the piston 71. The piston seal 75 is a separation seal member that seals between the positive-pressure chamber 711 and the back-pressure chamber 712 to thereby liquid-tightly separate them, and complements the function of the piston 71.

The spring 73 is a compression coil spring set in the back-pressure chamber 712, and biases the piston 71 from the back-pressure chamber 712 side toward the positive-pressure chamber 711 side. The spring 73 generates the reaction force according to the compression amount.

Further, the spring 73 includes a first spring 731 and a second spring 732. The first spring 731 is smaller in diameter, shorter in length, and smaller in wire diameter than the second spring 732. The first spring 731 and the second spring 732 are disposed in series between the piston 71 and the spring containing portion 722 via a retainer member 74.

The fluid passages 11 connect the hydraulic pressure chambers 52 of the master cylinder 5 and the wheel cylinders 2 to each other therebetween. The fluid passage 11P branches into a fluid passage I la and a fluid passage 11d. The fluid passage 11S branches into a fluid passage 11b and a fluid passage 11c.

The shut-off valves (the electromagnetic valves) 12 are normally-opened (opened when no electric power is supplied thereto) electromagnetic proportional valves provided in the fluid passages 11. The electromagnetic proportional valve can realize an arbitrary opening degree according to an electric current supplied to a solenoid.

Each of the fluid passages 11 is divided into a fluid passage 11A on the master cylinder 5 side and a fluid passage 11B on the wheel cylinder 2 side by the shut-off valve 12. Solenoid IN valves (the electromagnetic valves) 13 are normally-opened electromagnetic proportional valves provided in correspondence with the respective wheels FL to RR (in the fluid passages 11a to 11d) on the wheel cylinder 2 side (the fluid passages 11B) with respect to the shut-off valves 12 in the fluid passages 11. Bypass fluid passages 14 are provided in the fluid passages 11. The bypass fluid passages 14 bypass the solenoid IN valves 13. A check valve 15 is provided in each of the bypass fluid passages 14. The check valve 15 permits only a flow of the brake fluid from the wheel cylinder 2 side toward the master cylinder 5 side.

An intake pipe 16 connects the reservoir tank 6 and an internal reservoir 17 to each other. A fluid passage 18 connects the internal reservoir 17 and the intake side of the pump 21 to each other. A fluid passage 19 connects the discharge side of the pump 21 and a portion in each of the fluid passages 11B between the shut-off valve 12 and the solenoid IN valves 13. The fluid passage 19 branches into a fluid passage 19P of the P system and a fluid passage 19S of the S system. These fluid passages 19P and 19S are connected to the fluid passages 11P and 11S, respectively. These fluid passages 19P and 19S function as a communication passage connecting the fluid passages 11P and 11S to each other. Communication valves (the electromagnetic valves) 20 are normally-closed (closed when no electric power is supplied thereto) ON-OFF valves provided in the fluid passages 19. The ON/OFF valve is switched so as to be either opened or closed in a binary manner according to an electric current supplied to a solenoid.

The pump 21 generates the wheel cylinder hydraulic pressures by generating the hydraulic pressures in the fluid passages 11 using the brake fluid supplied from the reservoir tank 6. The pump 21 is connected to the wheel cylinders 2a to 2d via the fluid passages 19P and 19S and the fluid passages 11P and 11S, and increases the pressures in the wheel cylinders 2 by discharging the brake fluid to the fluid passages 19P and 19S.

A fluid passage 22 connects a branch point between the two fluid passages 19P and 19S and fluid passages 23. A pressure adjustment valve (the electromagnetic valve) 24 is provided in the fluid passage 22. The pressure adjustment valve 24 is a normally-opened electromagnetic proportional valve. The fluid passages 23 connect the wheel cylinder 2 side of the fluid passages 11B with respect to the solenoid IN valves 13, and the internal reservoir 17. Solenoid OUT valves (the electromagnetic valves) 25 are normally-closed ON-OFF valves provided in the fluid passages 23.

The fluid passage 26 branches off from the fluid passage 11A of the P system to be connected to the positive-pressure chamber 711 of the stroke simulator 7. Alternatively, the fluid passage 26 may be arranged so as to directly connect the P hydraulic pressure chamber 52P and the positive-pressure chamber 711 to each other without the intervention of the fluid passage 11P (11A).

The fluid passage 27 connects the back-pressure chamber 712 of the stroke simulator 7 and the fluid passages 11 to each other therebetween. More specifically, the fluid passage 27 branches off from a portion in the fluid passage 11P (11B) between the shut-off valve 12P and the solenoid IN valves 13 to be connected to the back-pressure chamber 712.

A stroke simulator IN valve (the electromagnetic valve) 28 is a normally-closed ON-OFF valve provided in the fluid passage 27. The fluid passage 27 is divided into a fluid passage 27A on the back-pressure chamber 712 side and a fluid passage 27B on the fluid passage 11 side by the stroke simulator IN valve 28.

A bypass fluid passage 29 is provided in parallel with the fluid passage 27 while bypassing the stroke simulator valve IN 28. The bypass fluid passage 29 connects the fluid passage 27A and the fluid passage 27B to each other therebetween. A check valve 30 is provided in the bypass fluid passage 29. The check valve 30 permits a flow of the brake fluid heading from the fluid passage 27A toward the fluid passage 11 (27B) side, and prohibits a flow of the brake fluid in the opposite direction therefrom.

A fluid passage 31 connects the back-pressure chamber 712 of the stroke simulator 7 and the fluid passages 23 to each other therebetween. A stroke simulator OUT valve (the electromagnetic valve) 32 is a normally-closed ON-OFF valve provided in the fluid passage 31. A bypass fluid passage 33 is provided in parallel with the fluid passage 31 while bypassing the stroke simulator OUT valve 32. A check valve 34 is provided in the bypass fluid passage 33. The check valve 34 permits a flow of the brake fluid heading from the fluid passage 23 side toward the back-pressure chamber 712 side, and prohibits a flow of the brake fluid in the opposite direction therefrom.

A master cylinder hydraulic pressure sensor 35 is provided between the shut-off valve 12P and the master cylinder 5 (the fluid passage 11A) in the fluid passage 11P. The master cylinder hydraulic pressure sensor 35 detects a hydraulic pressure at this portion (the master cylinder hydraulic pressure and the hydraulic pressure in the positive-pressure chamber 711). Wheel cylinder hydraulic pressure sensors (a P-system pressure sensor and an S-system pressure sensor) 36 are provided between the shut-off valves 12 and the solenoid IN valves 13 in the fluid passages 11. The wheel cylinder hydraulic pressure sensors 36 detect hydraulic pressures at these portions (the wheel cylinder hydraulic pressures). A discharge pressure sensor 37 is provided between the discharge side of the pump 21 and the communication valves 20 in the fluid passage 19. The discharge pressure sensor 37 detects a hydraulic pressure at this portion (a pump discharge pressure).

A first system is formed by a brake system (the fluid passages 11) that connects the hydraulic pressure chambers 52 of the master cylinder 5 and the wheel cylinders 2 to each other therebetween with the shut-off valves 12 opened. This first system can realize pressing force brake (non-boosting control) by generating the wheel cylinder hydraulic pressures from the master cylinder hydraulic pressures generated using the pressing force. On the other hand, a second system is formed by a brake system (the fluid passage 19, the fluid passage 22, the fluid passages 23, and the like) that includes the pump 21 and connects the reservoir tank 6 and the wheel cylinders 2 to each other therebetween with the shut-off valves 12 closed. This second system constructs a so-called brake-by-wire device, which generates the wheel cylinder hydraulic pressures from the hydraulic pressure generated using the pump 21, and can realize the boosting control or the like as brake-by-wire control. At the time of the brake-by-wire control, the stroke simulator 7 creates the operation reaction force accompanying the driver's brake operation.

### (Configuration of Control Unit)

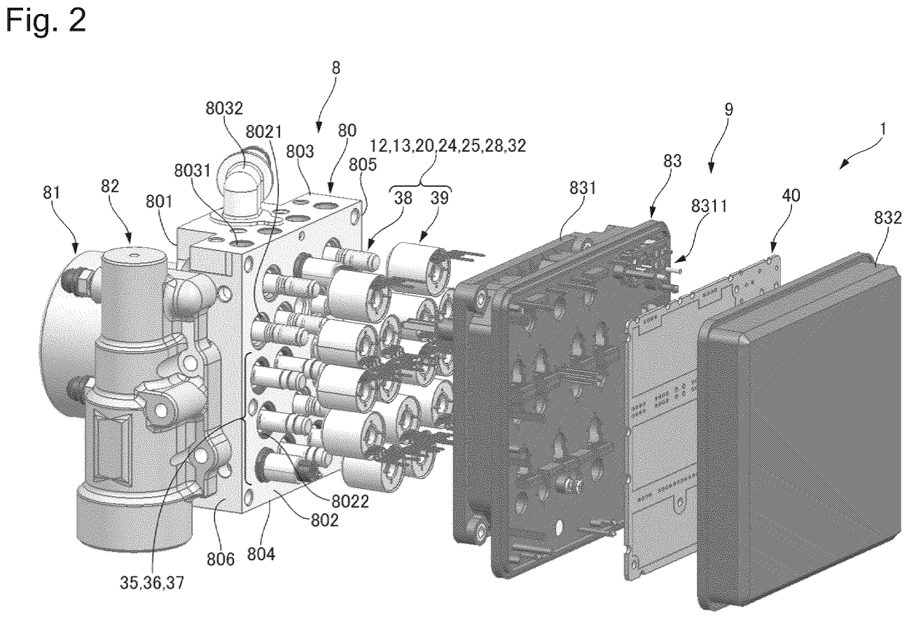

The control unit 9 includes a first CPU (CPU1) 9a and a second CPU (CPU2) 9b mounted on a one or single control board 40 (refer to FIG. 2), and controls the actuation of the hydraulic pressure unit 8.

Information regarding the running state transmitted from the vehicle side (the wheel speed and the like) is input to the control unit 9 in addition to detection values transmitted from the stroke sensor 60 and the hydraulic pressure sensors 35 to 37.

### (Operation of Control Unit)

The control unit 9 performs information processing according to a built-in program based on the input various kinds of information to calculate a target wheel cylinder hydraulic pressure of each of the wheel cylinders 2. The control unit 9 outputs an instruction signal to each of the actuators in the hydraulic pressure unit 8 in such a manner that the wheel cylinder hydraulic pressure in the wheel cylinder 2 matches the target wheel cylinder hydraulic pressure.

As a result, the brake control apparatus 1 can realize various kinds of brake control (boosting control, anti-lock control, brake control for vehicle motion control, brake-by-wire control, autonomous brake control, regenerative cooperative brake control, and the like).

The boosting control assists the brake operation by generating a brake hydraulic pressure by which the driver's brake pressing force is insufficient. The anti-lock control prevents a braking slip (a lock tendency) of each of the wheels FL to RR. The vehicle motion control is vehicle behavior stabilization control for preventing a sideslip and the like. The brake-by-wire control is brake control that electrically detects the driver's brake operation on the brake pedal 3 and controls the hydraulic pressure unit 8. The master cylinder 5 and the wheel cylinder 2 of each of the wheels FL to RR are connected to each other for a fail-safe purpose. The autonomous brake control is preceding vehicle following control, autonomous emergency brake, or the like. The regenerative cooperative brake control controls the wheel cylinder hydraulic pressures so as to achieve a target deceleration in cooperation with the regenerative brake.

In the first embodiment, the anti-lock control is set as a system for which redundancy is required.

Therefore, redundancy based on two systems is established by setting the control unit 9 in such a manner that both a control signal S1 of the first CPU (CPU1) 9a and a control signal S2 of the second CPU (CPU2) 9b can be transmitted to the motor 211 of the pump 21, can be transmitted to each of the solenoid IN valves 13a to 13d, which can increase the brake hydraulic pressures to supply to the wheel cylinders 2a to 2d, respectively, and can be transmitted to each of the solenoid OUT valves 25a to 25d, which can reduce the brake hydraulic pressures to supply to the wheel cylinders 2a to 2d, respectively.

The control unit 9 is set in such a manner that only the control signal S1 of the first CPU (CPU1) 9a can be transmitted to the shut-off valves 12, the communication valves 20, the pressure adjustment valve 24, the stroke simulator IN valve 28, and the stroke simulator OUT valve 32.

FIG. 2 is an exploded perspective view of main parts of the brake control apparatus according to the first embodiment.

The hydraulic pressure unit 8 includes a hydraulic pressure unit housing 80, a motor case 81, and a stroke simulator case 82.

The hydraulic pressure unit housing (hereinafter referred to as the housing) 80 is made from, for example, an aluminum alloy, and is a generally cuboidal casing including a front surface 801, a back surface 802, a top surface 803, a bottom surface 804, a left side surface 805, and a right side surface 806. The housing 80 includes each of the fluid passages (the fluid passages 11 and the like) formed inside it.

Further, the housing 80 contains the pump 21, each of the electromagnetic valves (the shut-off valves 12 and the like), and each of the hydraulic pressure sensors (the master cylinder hydraulic pressure sensor 35 and the like) inside it.

Four wheel cylinder ports 8031 are formed and a nipple 8032 is also mounted on the top surface 803 of the housing 80.

The wheel cylinder ports 8031 are connected to the wheel cylinders 2 via not-illustrated wheel cylinder pipes. The intake pipe 16 is connected to the nipple 8032. Fifteen valve containing holes 8021 and four sensor containing holes 8022 are formed on the back surface 802 of the housing 80. A valve portion 38 of each of the electromagnetic valves (the shut-off valves 12 and the like) is contained in each of the valve containing holes 8021. Each of the hydraulic pressure sensors (the master cylinder hydraulic pressure sensor 35 and the like) is contained in each of the sensor containing holes 8022.

The motor case 81 is a metallic cylindrical member, and contains the motor 211 inside it. The motor case 81 is fixed to the front surface 801 of the housing 80.

The stroke simulator case 82 is made from an aluminum alloy, and contains the stroke simulator 7 inside it. The stroke simulator case 82 is fastened to the right side surface 806 of the housing 80 using a not-illustrated screw.

The control unit 9 includes a control unit case 83.

The control unit case 83 is made from a resin material, and contains a solenoid 39 of each of the electromagnetic valves (the shut-off valves 12 and the like), and the control board 40 on which the two first CPU (CPU1) 9a and second CPU (CPU2) 9b are mounted.

The control unit case 83 includes a main body portion 831 and a cover 832. The main body portion 831 has a front surface side (the housing 80 side) formed into a recessed shape, and covers each of the solenoids 39.

The main body portion 831 is fastened to the back surface 802 of the housing 80 using a not-illustrated screw.

The main body portion 831 includes a control board containing portion 8311 on the back surface side thereof (the opposite side from the housing 80 side). The control board 40 is attached in the control board containing portion 8311.

The cover 832 is a cover member fixed to the main body portion 831, and covering the control board containing portion 8311.

The control board 40 controls the states of electric power supply to the motor 211 and each of the solenoids 39 by the two first CPU (CPU1) 9a and second CPU (CPU2) 9b. The control board 40 is attached in the control board containing portion 8311 in parallel with the back surface 802.

As described above, redundancy based on two systems is established by setting the control unit 9 in such a manner that both the control signal S1 of the first CPU (CPU1) 9a and the control signal S2 of the second CPU (CPU2) 9b can be transmitted to the motor 211 of the pump 21, can be transmitted to each of the solenoid IN valves 13a to 13d, which can increase the brake hydraulic pressures to supply to the wheel cylinders 2a to 2d, respectively, and can be transmitted to each of the solenoid OUT valves 25a to 25d, which can reduce the brake hydraulic pressures to supply to the wheel cylinders 2a to 2d, respectively.

The control unit 9 is set in such a manner that only the control signal S1 of the first CPU (CPU1) 19a can be transmitted to the shut-off valves 12, the communication valves 20, the pressure adjustment valve 24, the stroke simulator IN valve 28, and the stroke simulator OUT valve 32.

Due to that, the anti-lock control is set as a system for which redundancy is required, and redundancy is established only by the one or single control board 40, and therefore the brake control apparatus 1 can both curb cost and minimize a size increase thereof at the same time.

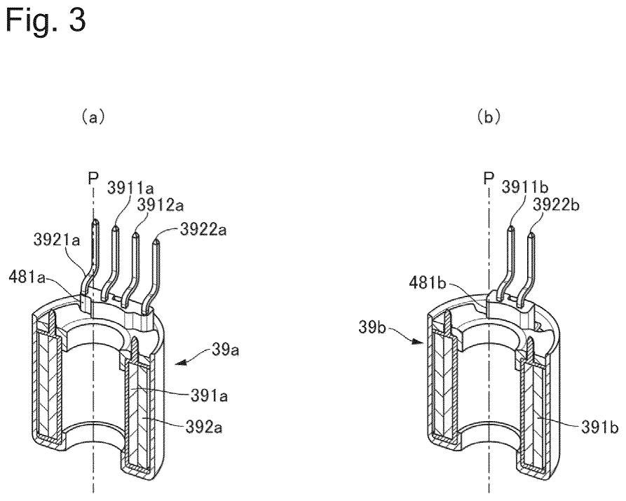

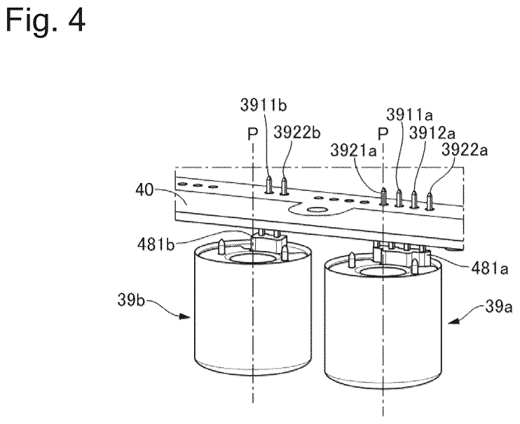

FIG. 3(a) is a cross-sectional perspective view of a four-terminal solenoid according to the first embodiment, and FIG. 3(b) is a cross-sectional perspective view of a two-terminal solenoid according to the first embodiment. FIG. 4 is a perspective view illustrating how the four-terminal solenoid and the two-terminal solenoid according to the first embodiment are mounted on the control board.

When the four-terminal solenoid 39a is viewed from a P direction of an axis around which the coil is wound, individual terminals 3911a, 3912a, 3921a, and 3922a are arranged linearly in the order of the second positive electrode terminal 3921a, the first positive electrode terminal 391 la, the second negative electrode terminal 3912a, and the first negative electrode terminal 3922a. Each of the terminals 3911a, 3912a, 3921a, and 3922a is held on a not-illustrated resin bobbin around which a first coil 391a and a second coil 392a are wound, and a terminal retainer portion 481a.

The first positive electrode terminal 3911a and the first negative electrode terminal 3922a are connected to the first coil 391a, and the second positive electrode terminal 3921a and the second negative electrode terminal 3912a are connected to the second coil 392a.

Further, each of the terminals 391 la, 3912a, 3921a, and 3922a is mounted on the control board 40 in such a manner that the first positive electrode terminal 3911a and the first negative electrode terminal 3922a are connected to the first CPU (CPU1) 9a, and the second positive electrode terminal 3921a and the second negative electrode terminal 3912a are connected to the second CPU (CPU2) 9b.

At the solenoid 39a of each of the electromagnetic valves, a direction in which an electric current flows is set in such a manner that the direction of a magnetic field generated when an electric current is supplied to the first coil 391a, and the direction of a magnetic field generated when an electric current is supplied to the second coil 392a match each other. The coil of the motor 211 is also configured similarly to the solenoid 39, and therefore the illustration and the description thereof will be omitted herein.

When the two-terminal solenoid 39b is viewed from the P direction of the axis around which the coil is wound, individual terminals 3911b and 3922b are arranged linearly in the order of the positive electrode terminal 3911b and the negative electrode terminal 3922b. Each of the terminals 3911b and 3922b is held on a not-illustrated resin bobbin around which a coil 391b is wound, and a terminal retainer portion 481b.

Similarly, each of the terminals 3911b and 3922b is connected to the coil 391b, and is mounted on the control board 40 in such a manner that each of the terminals 3911b and 3922b is connected to the first CPU (CPU1) 9a.

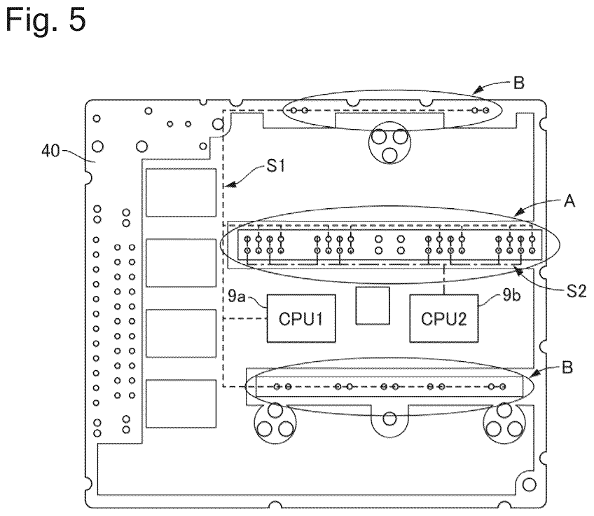

FIG. 5 is a plan view of the control board according to the first embodiment.

A plurality of four-terminal solenoids 39a, which controls the motor 211 of the pump 21, and controls each of the solenoid IN valves 13a to 13d and controls each of the solenoid OUT valves 25a to 25b, is mounted on an anti-lock control electromagnetic valve mount portion A of the control board 40. A plurality of two-terminal solenoids 39b, which controls each of the shut-off valves 12P and 12S, each of the communication valves 20P and 20S, the pressure adjustment valve 24, the stroke simulator IN valve 28, and the stroke simulator OUT valve 32, is mounted on a remaining control electromagnetic valve mount portion B of the control board 40.

Next, the function effects will be described.

The brake control apparatus according to the first embodiment brings about function effects that will be listed below.
(1) The brake control apparatus according to the first embodiment is configured in such a manner that the anti-lock control is set as a system for which redundancy is required, and redundancy is established by only the one or single control board 40.

Accordingly, using only the one control board 40 allows the brake control apparatus to both curb cost and minimize a size increase at the same time, and also allows the brake control apparatus to establish redundancy for the anti-lock control, which is a required system.

### Second Embodiment

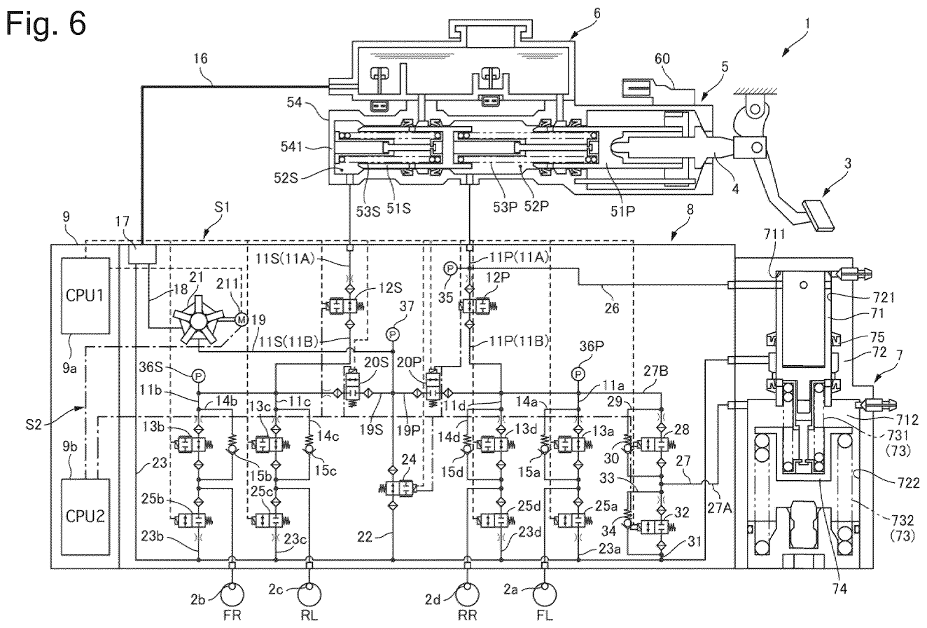

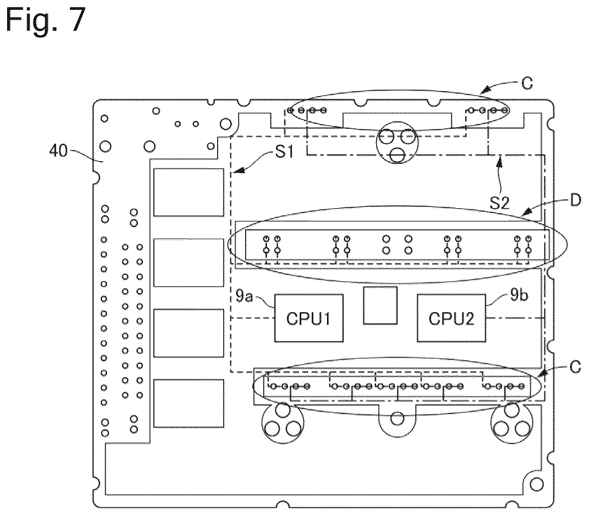

FIG. 6 is a schematic view of a brake control apparatus according to a second embodiment, and FIG. 7 is a plan view of a control board according to the second embodiment.

The anti-lock control is set as a system for which redundancy is required in the first embodiment, but the brake-by-wire control is set as a system for which redundancy is required in the second embodiment.

As illustrated in FIG. 6, redundancy based on two systems is established by setting the control unit 9 in such a manner that both the control signal S1 of the first CPU (CPU1) 9a and the control signal S2 of the second CPU (CPU2) 9b can be transmitted to the motor 211 of the pump 21, can be transmitted to each of the shut-off valves 12P and 12S, which can block communication between the master cylinder 5 and each of the wheel cylinders 2a to 2d, can be transmitted to each of the communication valves 20P and 20S, which can establish communication between the pump 21 for generating the control hydraulic pressure to increase the pressure in each of the wheel cylinders 2a to 2d and each of the wheel cylinders 2a to 2d, can be transmitted to the pressure adjustment valve 24, and can be transmitted to the stroke simulator IN valve 28 and the stroke simulator OUT valve 32, which can block communication between the master cylinder 5 and the stroke simulator 7.

The control unit 9 is set in such a manner that only the control signal S1 of the first CPU (CPU1) 9a can be transmitted to each of the solenoid IN valves 13a to 13d and each of the solenoid OUT valves 25a to 25d.

Further, as illustrated in FIG. 7, a plurality of four-terminal solenoids 39a, which controls the motor 211 of the pump 21, each of the shut-off valves 12P and 12S, each of the communication valves 20P and 20S, the pressure adjustment valve 24, the stroke simulator IN valve 28, and the stroke simulator OUT valve 32, is mounted on a brake-by-wire control electromagnetic valve mount portion C of the control board 40. A plurality of two-terminal solenoids 39b, which controls each of the solenoid IN valves 13a to 13d and each of the solenoid OUT valves 25a to 25d, is mounted on an anti-lock control electromagnetic valve mount portion D of the control board 40.

Other than that, the second embodiment is configured similarly to the first embodiment, and therefore will not be described regarding configurations shared with the first embodiment, which are identified by the same reference numerals as the first embodiment.

Next, the function effects will be described.

The brake control apparatus according to the second embodiment brings about function effects similar to the first embodiment.

### Third Embodiment

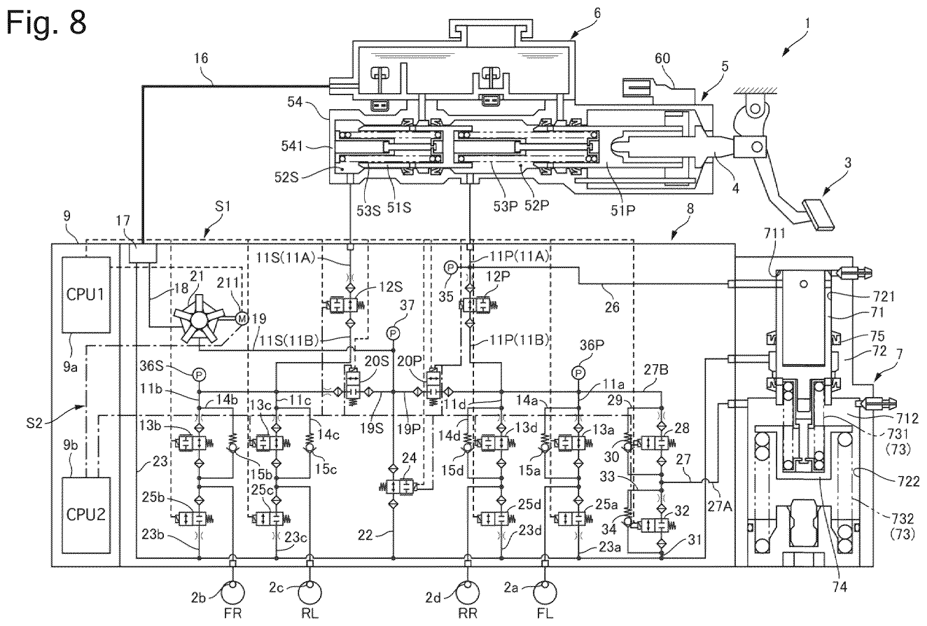

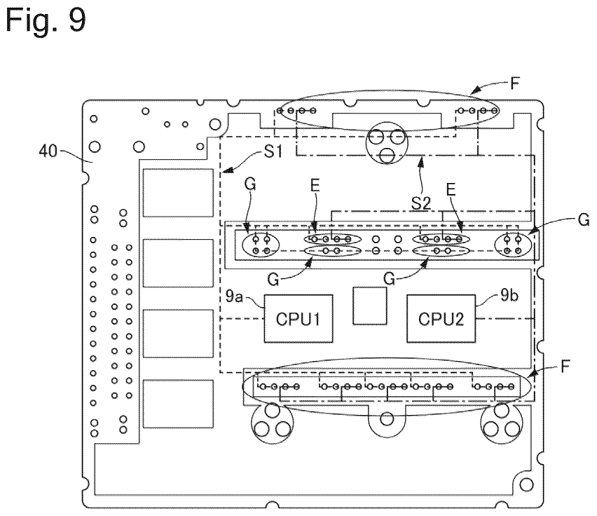

FIG. 8 is a schematic view of a brake control apparatus according to a third embodiment, and FIG. 9 is a plan view of a control board according to the third embodiment.

In the second embodiment, the brake-by-wire control is set as a system for which redundancy is required. On the other hand, in the third embodiment, each of the solenoid IN valves 13c and 13d, which are the pressure increase valves on each rear wheel (the rear left wheel RL and the rear right wheel RR) side, is further added to set a system for which redundancy is required, because each rear wheel (the rear left wheel RL and the rear right wheel RR) may be locked during the pressure increase control when simplified anti-lock control of simultaneously increasing/reducing the pressure at each wheel (the front left wheel FL, the front right wheel FR, the rear left wheel RL, and the rear right wheel RR) using the brake-by-wire control is performed at the time of a failure in the anti-lock control.

As illustrated in FIG. 8, redundancy based on two systems is established by setting the control unit 9 in such a manner that both the control signal S1 of the first CPU (CPU1) 9a and the control signal S2 of the second CPU (CPU2) 9b can be transmitted to the motor 211 of the pump 21, can be transmitted to each of the shut-off valves 12P and 12S, which can block communication between the master cylinder 5 and each of the wheel cylinders 2a to 2d, can be transmitted to each of the communication valves 20P and 20S, which can establish communication between the pump 21 for generating the control hydraulic pressure to increase the pressure in each of the wheel cylinders 2a to 2d and each of the wheel cylinders 2a to 2d, can be transmitted to the pressure adjustment valve 24, can be transmitted to the stroke simulator IN valve 28 and the stroke simulator OUT valve 32, which can block communication between the master cylinder 5 and the stroke simulator 7, and can be transmitted to each of the solenoid IN valves 13c and 13d.

The control unit 9 is set in such a manner that only the control signal S1 of the first CPU (CPU1) 9a can be transmitted to each of the solenoid IN valves 13a and 13b and each of the solenoid OUT valves 25a to 25d.

Further, as illustrated in FIG. 9, a plurality of four-terminal solenoids 39a, which control the motor 211 of the pump 21, control each of the shut-off valves 12P and 12S, control each of the communication valves 20P and 20S, control the pressure adjustment valve 24, control the stroke simulator IN valve 28, and control the stroke simulator OUT valve 32, is mounted on a brake-by-wire control electromagnetic valve mount portion F of the control board 40. A plurality of four-terminal solenoids 39a, which control each of the solenoid IN valves 13c and 13d, is mounted on a rear-wheel lock control electromagnetic valve mount portion E of the control board 40. A plurality of two-terminal solenoids 39b, which control each of the solenoid IN valves 13a and 13b and each of the solenoid OUT valves 25a to 25d, is mounted on an anti-lock control electromagnetic valve mount portion G of the control board 40.

Other than that, the third embodiment is configured similarly to the second embodiment, and therefore will not be described regarding configurations shared with the second embodiment, which are identified by the same reference numerals as the first embodiment.

Next, the function effects will be described.

The brake control apparatus according to the third embodiment brings about an function effect of being able to prevent each rear wheel (the rear left wheel RL and the rear right wheel RR) from being locked during the pressure increase control when performing the simplified anti-lock control of simultaneously increasing/reducing the pressure at each wheel (the front left wheel FL, the front right wheel FR, the rear left wheel RL, and the rear right wheel RR) using the brake-by-wire control, in addition to the function effects of the second embodiment.

### Other Embodiments

Having described the embodiments for implementing the present invention, the specific configuration of the present invention is not limited to the configurations of the embodiments, and the present invention also includes a design modification and the like thereof made within a range that does not depart from the spirit of the present invention, if any.

The present application claims priority under the Paris Convention to Japanese Patent Application No. 2022-142864 filed on Sep. 8, 2022. The entire disclosure of Japanese Patent Application 2022-142864 filed on Sep. 8, 2022 including the specification, the claims, the drawings, and the abstract is incorporated herein by reference in its entirety.

### REFERENCE SIGNS LIST

1 brake control apparatus
2 wheel cylinder
12 shut-off valve (electromagnetic valve)
13 solenoid IN valve (electromagnetic valve)
20 communication valve (electromagnetic valve)
24 pressure adjustment valve (electromagnetic valve)
25 solenoid OUT valve (electromagnetic valve)
28 stroke simulator IN valve (electromagnetic valve)
32 stroke simulator OUT valve (electromagnetic valve)
40 control board
80 hydraulic pressure unit housing (housing)
391a first coil
392a second coil
3911a first positive electrode terminal (first terminal)
3922a first negative electrode terminal (second terminal)
3921a second positive electrode terminal (third terminal)
3912a second negative electrode terminal (fourth terminal)

1. A brake control apparatus comprising:
an electromagnetic valve device including a first coil to which a first terminal and a second terminal are connected, and a second coil to which a third terminal and a fourth terminal are connected, in parallel with each other;
a housing where the electromagnetic valve device is disposed; and
a one control board disposed offset from one end surface of the housing in a direction of an axis around which the first coil is wound,
wherein all of the terminals are connected to the control board.

2. The brake control apparatus according to claim 1, wherein the electromagnetic valve device includes a first electromagnetic valve capable of increasing a brake hydraulic pressure to supply to a wheel cylinder, and a second electromagnetic valve capable of reducing the brake hydraulic pressure to supply to the wheel cylinder.

3. The brake control apparatus according to claim 1, wherein the electromagnetic valve device includes a third electromagnetic valve capable of blocking communication between a master cylinder and a wheel cylinder, and a fourth electromagnetic valve capable of blocking communication between the master cylinder and a stroke simulator.

4. The brake control apparatus according to claim 3, wherein the electromagnetic valve device further includes a fifth electromagnetic valve capable of increasing a pressure at a rear wheel brake of a vehicle.
